(19) United States
(12) Patent Application Publication
(10) Pub. No.: US 2014/0333248 A1
(43) Pub. Date: Nov. 13, 2014

(54) SERVO MOTOR CONTROL SYSTEM

(71) Applicant: FANUC Corporation, Yamanashi (JP)

(72) Inventor: Kunitaka KOMAKI, Minamitsuru-gun (JP)

(73) Assignee: FANUC Corporation, Yamanashi (JP)

(21) Appl. No.: 14/270,386

(22) Filed: May 6, 2014

(30) Foreign Application Priority Data
May 9, 2013 (JP) 2013-099241

(51) Int. Cl. G05B 11/01; G05B 15/02

(52) U.S. Cl. CPC G05B 11/011; G05B 15/02
USPC 318/569

(57) ABSTRACT

All correction data is stored in the main memory of a numerical controller in advance. Of all correction data, the minimum data required for correction is transferred, for each interpolation cycle, to a built-in memory of a peripheral control LSI included in a servo control unit. A servo control processor performs repetitive control using the data transferred to the memory.

### BACKGROUND OF THE INVENTION

1. Field of the Invention

The present invention relates to a servo motor control system.

2. Description of the Related Art

In machine tools such as machining centers, repetitive control is used to achieve high-speed and high-precision traceability in response to a repetitive instruction. In repetitive control, correction data is stored in relation to the position of a figure in a repeatedly-instructed pattern and the positional deviation is corrected based on the position, so that the positional deviation can be reduced even if the speed varies. The larger this correction data is, the longer the duration of repetitive control is. Conventionally, a memory for storing correction data is installed in the periphery of a servo control processor that makes control.

As disclosed in Japanese Patent Application Lain-Open No. 9-69004, a numerical controller has function blocks such as a numerical control unit and a servo motor control unit, which are interconnected via a bus. FIG. 6 shows an example of the structure of such a numerical controller. A numerical controller 10 includes a numerical control unit 11, a motor control unit 12, and an amplifier interface unit 13. The above functional blocks, i.e., the numerical control unit 11 and the motor control unit 12, include a processor 20 and a processor 30 as processors that perform control processes, a memory 21 and a memory 31, and a peripheral control LSI 22 and a peripheral control LSI 32 that function as bridges between an internal bus 14 interconnecting these functional blocks and the processors, and so on. The amplifier interface unit 13 has a peripheral control LSI 42 and is connected to the numerical control unit 11 and the motor control unit 12 via the internal bus 14. The motor driving amplifier 18, which is connected to the amplifier interface unit 13 via a serial servo bus 19, drives a motor according to an instruction from the motor control unit 12.

As disclosed in Japanese Patent Application Lain-Open No. 2012-58824, repetitive control is used in machine tools to achieve high-speed and high-precision traceability in response to a repetitive instruction. Repetitive control requires a memory to store correction data. Conventionally, a specific memory such as the memory 31 shown in FIG. 6 was installed in the periphery of the servo control processor.

Since repetitive control requires the memory to store the corrective data corresponding to the duration of repetition, a larger memory can extend the duration of repetitive control. However, the capacity of memory that can be installed in the periphery of the servo control processor is restricted by the cost and space. If the capacity of memory that can be installed in the periphery of the servo control processor is small, the duration of repetitive control is shortened.

### SUMMARY OF THE INVENTION

The present invention addresses the above problem of the prior art technique with the object of providing a servo motor control system that can increase the capacity of memory for repetitive control without installing a specific memory for correction data in the servo control unit and reduce the packaging area and cost.

A servo motor control system according to the present invention includes a numerical control processor that creates an instruction for controlling a servo motor and outputs the created instruction to a servo control processor and the servo control processor that controls the servo motor based on the output instruction. The servo motor control system includes a first memory to which the servo control processor is able to refer, a second memory to which the numerical control processor is able to refer, a memory transfer means for transferring data from the second memory to the first memory, and a timing notification means for notifying the memory transfer means of a timing of memory transfer, in which, when the timing notification means instructs the memory transfer means to do memory transfer, the memory transfer means transfers data from the second memory to the first memory and the servo control processor controls the servo motor using the data transferred from the second memory to the first memory.

A servo motor control system according to the present invention includes a numerical control processor that creates an instruction for controlling a servo motor and outputs the created instruction to a servo control processor and the servo control processor that controls the servo motor based on the output instruction. The servo motor control system includes a first memory to which the servo control processor is able to refer, a second memory to which the numerical control processor is able to refer, a memory transfer means for transferring data between the first memory and the second memory, and a timing notification means for notifying the memory transfer means of a timing of memory transfer, in which, when the timing notification means instructs the memory transfer means to do memory transfer, the memory transfer means transfers data between the first memory and the second memory and the servo control processor controls the servo motor using the data transferred from the second memory to the first memory. The servo control processor reads data from and writes data to the first memory and the memory transfer means is able to transfer, to the second memory, the data written by the servo control processor to the first memory.

The servo control processor is able to perform repetitive control and correction data for repetitive control can be stored in the first memory.

According to the present invention with the above structure, it is possible to provide a servo motor control system that has the increased amount of memory for repetitive control and can reduce the packaging area and cost without installing a specific memory for correction data in the servo control unit.

### BRIEF DESCRIPTION OF THE DRAWINGS

The objects and features described above and others of the present invention will become obvious from the descriptions in embodiments below with reference to attached drawings. Among the drawings:

FIG. 1 is a block diagram schematically showing a servo control system according to the present invention;

FIG. 2 is a block diagram showing memory transfer that transfers correction data from the memory of a numerical control unit to the memory of a servo control unit;

FIG. 3 shows timings of memory transfer that transfers correction data from the memory of the numerical control unit to the memory of the servo control unit;

FIG. 4 shows timings of memory transfer that transfers correction data between the memory of the numerical control unit and the memory of the servo control unit;

FIG. 5 shows timings of memory transfer that transfers correction data between the memory of the numerical control unit and the memory of the servo control unit; and

FIG. 6 is a diagram showing a conventional servo control system.

### DETAILED DESCRIPTION OF THE PREFERRED EMBODIMENTS

In the embodiment described below, the components with the same functions as in the prior art technique are given the same reference numbers.

In an embodiment of the present invention, correction data is stored in the relatively large main memory of a numerical controller, the minimum required data is loaded, for each interpolation cycle, to a peripheral memory of the servo control processor, and repetitive control is performed. Reversely, the minimum required correction data corrected is stored, for each interpolation cycle, in the main memory.

Repeated control at any point of time only requires correction data around the point of time instead of all correction data. The peripheral control LSI for servo control has a memory insufficient to store all correction data, but sufficient to store the correction data required at any point of time. On the other hand, the main memory of the numerical controller has a memory sufficient to store all correction data. Accordingly, correction data is stored in the main memory of the numerical controller, the minimum required data is loaded, for each interpolation cycle, to the built-in memory of the servo control processor and, reversely, the minimum required correction data corrected is stored, for each interpolation cycle, in the main memory to enable execution of repetitive control.

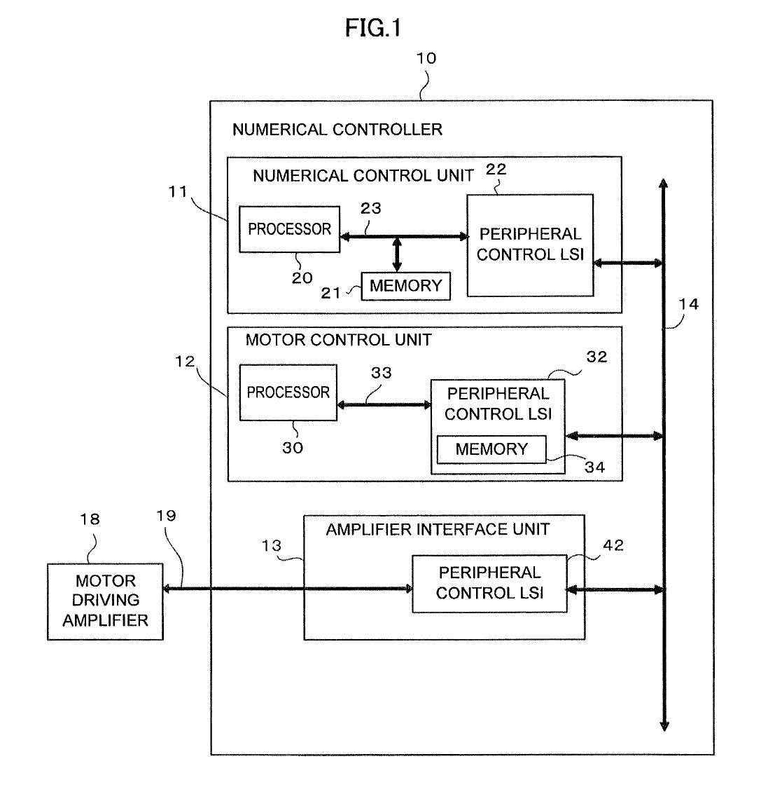

FIG. 1 is a block diagram schematically showing a servo control system according to the present invention. A numerical controller 10 includes a numerical control unit 11, a motor control unit 12, and an amplifier interface unit 13. The above functional blocks, i.e., the numerical control unit 11 and the motor control unit 12, include a numerical control processor 20 and a motor control processor 30 as processors that perform control processes, a memory 21 of large capacity and a memory 34 incorporated in a peripheral control LSI 32 as memories, and a peripheral control LSI 22 and the peripheral control LSI 32 that function as bridges between an internal bus 14 interconnecting these functional blocks and the processors, and so on. Reference numbers 23 and 33 represent buses.

The amplifier interface unit 13 has a peripheral control LSI 42 and is connected to the numerical control unit 11 and the motor control unit 12 via the internal bus 14. The motor driving amplifier 18, which is connected to the amplifier interface unit 13 via a serial servo bus 19, drives a motor according to an instruction from the motor control unit 12.

In the servo motor control system described above, repeated control at any point of time only requires correction data around the point of time instead of all correction data. Accordingly, in the numerical controller 10 shown in FIG. 1, the peripheral control LSI 32 for servo control has the memory 34, i.e., a built-in memory, insufficient to store all correction data, but sufficient to store the correction data required at any point of time. On the other hand, the memory 21, which is the main memory of the numerical controller 10, has a capacity sufficient to store all correction data.

Accordingly, correction data is stored in the main memory of the numerical controller 10, i.e., the memory 21 of the numerical control unit 11, and then the minimum data required for correction is transferred, for each interpolation cycle, to the memory 34 incorporated in the peripheral control LSI 32 in the motor control unit 12.

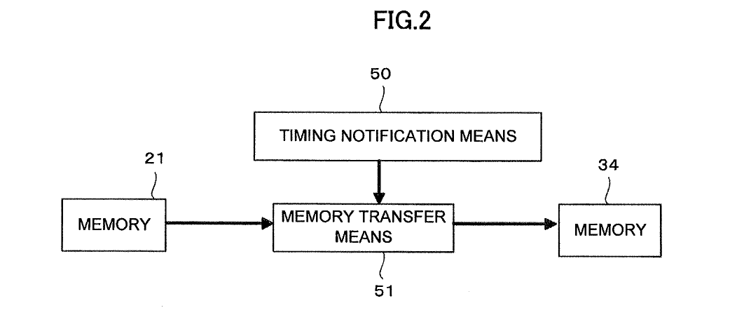

FIG. 2 is a block diagram showing memory transfer that transfers correction data from the memory 21 of the numerical control unit 11 to the memory 34 of the motor control unit 12. Timings at which memory transfer of correction data is performed from the memory 21, i.e., the main memory, to the memory 34, i.e., the built-in memory are generated by a timing notification means 50, more specifically the processor 30. The timing notification means 50 creates a transfer signal at timings with a constant cycle such as an interpolation cycle, using an internal counter (not shown) and notifies a memory transfer means 51, which is specifically the peripheral control LSI 32, of the transfer signal.

Upon receiving the transfer signal from the timing notification means 50, the memory transfer means 51 transfers data from the memory 21 to the memory 34. At this time, the memory transfer means 51 shifts each of the segments of correction data in the memory 21, i.e., main memory, by 1. After shifting to N, the number generally returns to 1 and this cycle is repeated as long as the machining continues. The processor 30, i.e., the servo control processor of the motor control unit 12, repeatedly performs repetitive control while reading data in the memory 34, i.e., the built-in memory.

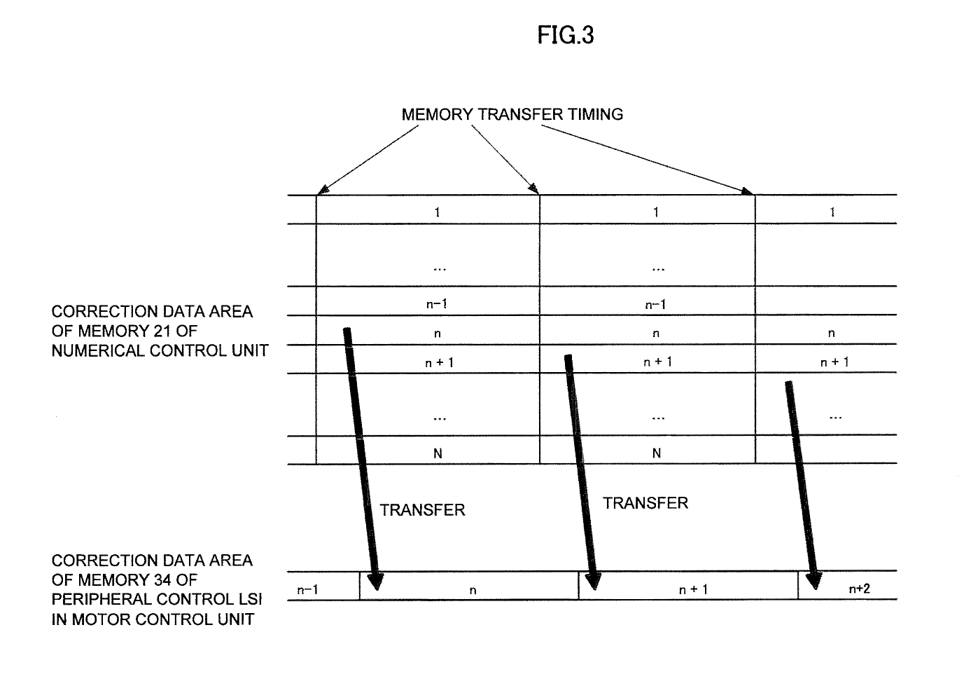

FIG. 3 shows timings of memory transfer that transfers correction data from the memory of the numerical control unit to the memory of the servo control unit. The correction data area in the memory 21, i.e., the main memory, is divided into N segments as shown in FIG. 3 and each segment stores correction data.

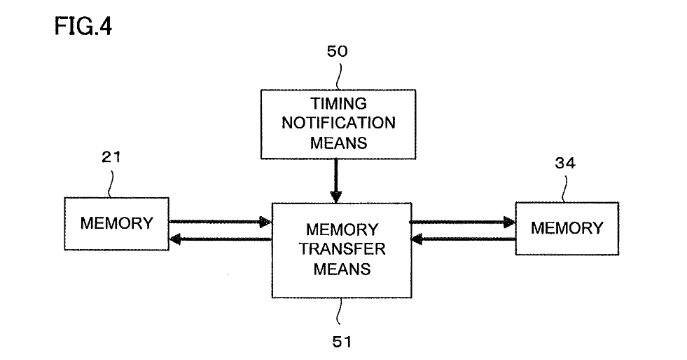

FIG. 4 shows timings of memory transfer that transfers correction data between the memory of the numerical control unit and the memory of the servo control unit.

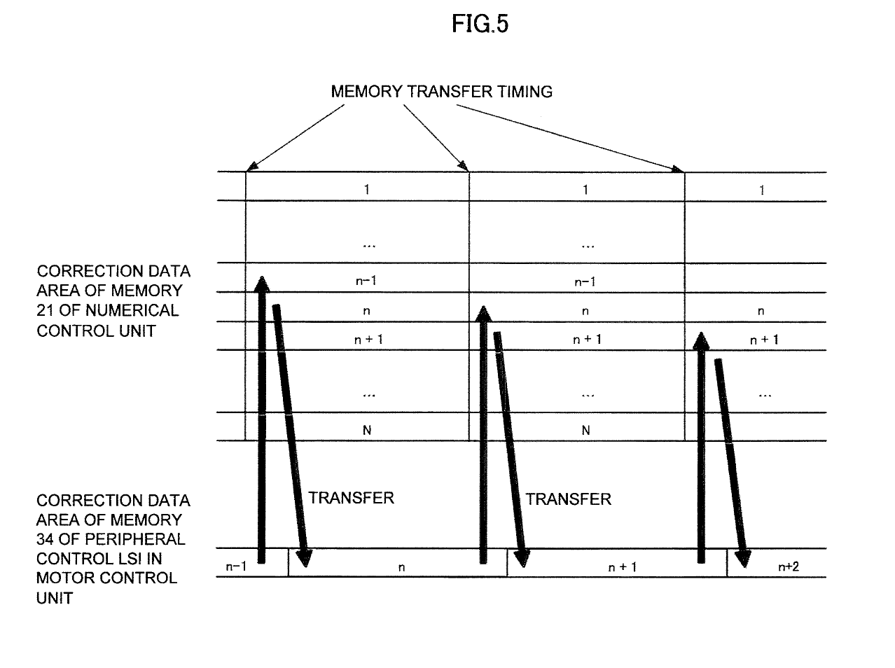

FIG. 5 shows timings of memory transfer that transfers correction data between the memory of the numerical control unit and the memory of the servo control unit. The correction data area in the memory 21, i.e., the main memory, is divided into N segments as shown in FIG. 5 and each segment stores correction data.

If the need to correct correction data arises while the servo control processor performs repetitive control, the servo control processor only needs to correct correction data in the memory 34, i.e., the internal memory, and the memory transfer means 51 stores the corrected correction data in the memory 21. Accordingly, the corrected correction data can be used in subsequent repeated cycles.

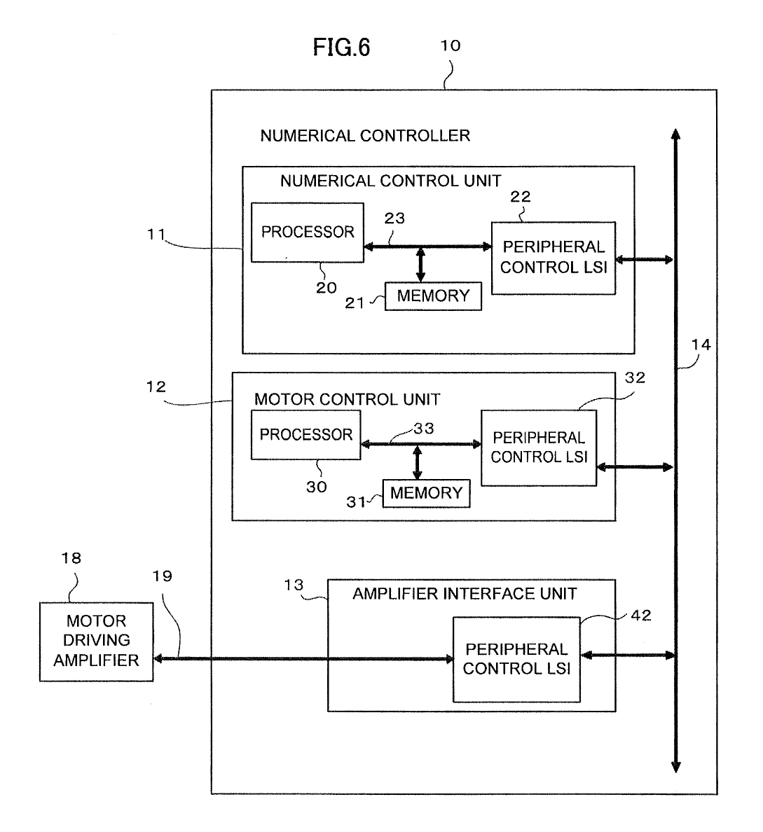

As described above, if the necessary correction data is transferred as appropriate from the memory 21 of the numerical control unit 11 to the memory 34, i.e., the built-in memory of the peripheral control LSI 32 of the motor control unit 12, then repetitive control can be performed and the memory 31 specific to correction data shown in FIG. 6 can be removed, thereby reducing the packaging area and cost. This also enables the use of a large-capacity memory, i.e., the memory 21, thereby increasing the duration of repetition.

1. A servo motor control system including a numerical control processor and a servo control processor, the numerical control processor creating an instruction for controlling a servo motor and outputting the created instruction to the servo control processor, the servo control processor controlling the servo motor based on the output instruction, the servo motor control system comprising:
a first memory to which the servo control processor configured to refer;
a second memory to which the numerical control processor configured to refer;
a memory transfer means for transferring data from the second memory to the first memory; and
a timing notification means for notifying the memory transfer means of a timing of memory transfer,
wherein, when the timing notification means instructs the memory transfer means to transfer memory, the memory transfer means transfers data from the second memory to the first memory and the servo control processor controls the servo motor using the data transferred from the second memory to the first memory.

2. A servo motor control system including a numerical control processor and a servo control processor, the numerical control processor creating an instruction for controlling a servo motor and outputting the created instruction to the servo control processor, the servo control processor controlling the servo motor based on the output instruction, the servo motor control system comprising:
a first memory to which the servo control processor configured to refer;
a second memory to which the numerical control processor configured to refer;
a memory transfer means for transferring data between the first memory and the second memory; and
a timing notification means for notifying the memory transfer means of a timing of memory transfer,
wherein, when the timing notification means instructs the memory transfer means to transfer memory, the memory transfer means transfers data between the first memory and the second memory and the servo control processor controls the servo motor using the data transferred from the second memory to the first memory.

3. The servo motor control system according to claim 2,
wherein the servo control processor reads data from and writes data to the first memory and the memory transfer means transfers, to the second memory, the data written by the servo control processor to the first memory.

4. The servo motor control system according to claim 1,
wherein the servo control processor performs repetitive control and the first memory stores correction data for repetitive control.

5. The servo motor control system according to claim 2,
wherein the servo control processor performs repetitive control and the first memory stores correction data for repetitive control.

6. The servo motor control system according to claim 3,
wherein the servo control processor performs repetitive control and the first memory stores correction data for repetitive control.
